(19) United States
(12) Patent Application Publication
(10) Pub. No.: US 2016/0150264 A1
(43) Pub. Date: May 26, 2016

(54) MULTIFUNCTION TELEVISION AND REMOTE ASSEMBLY

(71) Applicant: Christopher Coleman, New Orleans, LA (US)

(72) Inventor: Christopher Coleman, New Orleans, LA (US)

(21) Appl. No.: 14/551,282

(22) Filed: Nov. 24, 2014

(51) Int. Cl. H04N 21/422; H04N 21/4223; H04N 21/433

(52) U.S. Cl. CPC H04N 21/42203; H04N 21/4334; H04N 21/4223; H04N 21/4222; H04N 21/4221

(57) ABSTRACT

A television assembly includes a housing positioned on a support surface. A base display is coupled to the housing to be visible to an observer. A base processor is positioned within the housing and electrically coupled to the display. A camera is coupled to the housing and electrically coupled to the base processor. The camera records a video. A base transceiver positioned within the housing and electrically coupled to the base processor. The base transceiver is in electromagnetic communication with a communications network to deliver and receive a video from the communications network. A microphone is coupled to the housing to receive audible commands. The microphone is electrically coupled to the base processor to send the audible commands to the base processor. The base display depicts indicia associated with the audible commands.

### BACKGROUND OF THE DISCLOSURE

### Field of the Disclosure

The disclosure relates to television devices and more particularly pertains to a new television device for receiving and responding to audible commands.

### SUMMARY OF THE DISCLOSURE

An embodiment of the disclosure meets the needs presented above by generally comprising a housing positioned on a support surface. A base display is coupled to the housing to be visible to an observer. A base processor is positioned within the housing and electrically coupled to the display. A camera is coupled to the housing and electrically coupled to the base processor. The camera records a video. A base transceiver positioned within the housing and electrically coupled to the base processor. The base transceiver is in electromagnetic communication with a communications network to deliver and receive a video from the communications network. A microphone is coupled to the housing to receive audible commands. The microphone is electrically coupled to the base processor to send the audible commands to the base processor. The base display depicts indicia associated with the audible commands.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a television assembly according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is a left side perspective view of a remote an embodiment of the disclosure.

FIG. 6 is a schematic view of an embodiment of the disclosure.

FIG. 7 is a top view of remote of an embodiment of the disclosure.

FIG. 8 is a top perspective view of an embodiment of the disclosure.

### DESCRIPTION OF THE PREFERRED EMBODIMENT

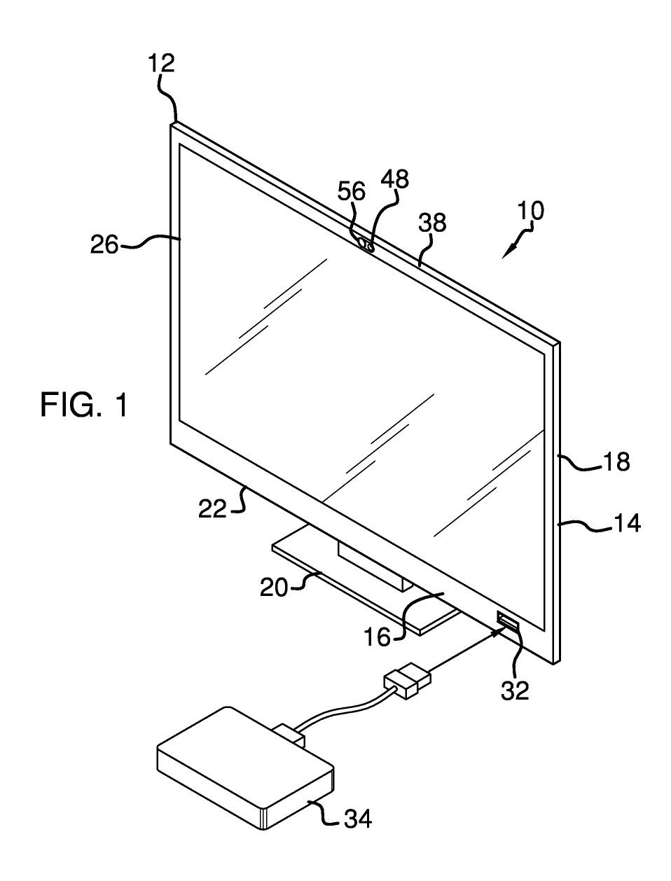

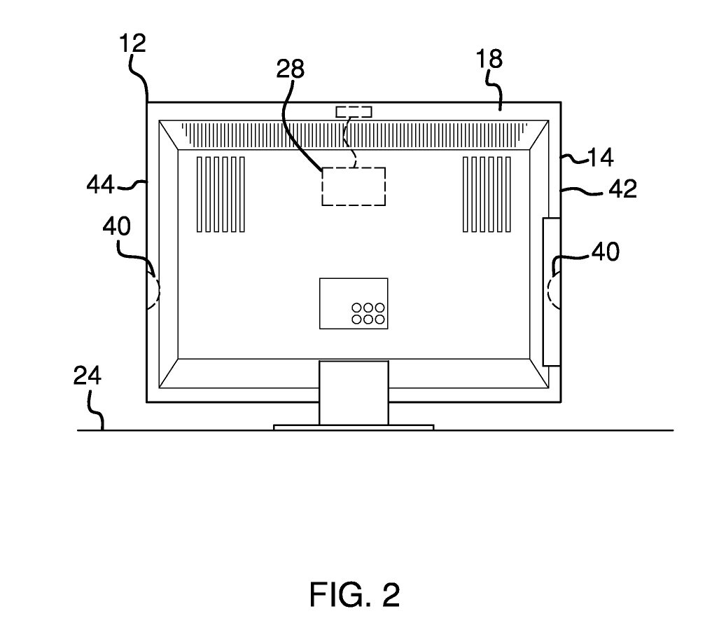

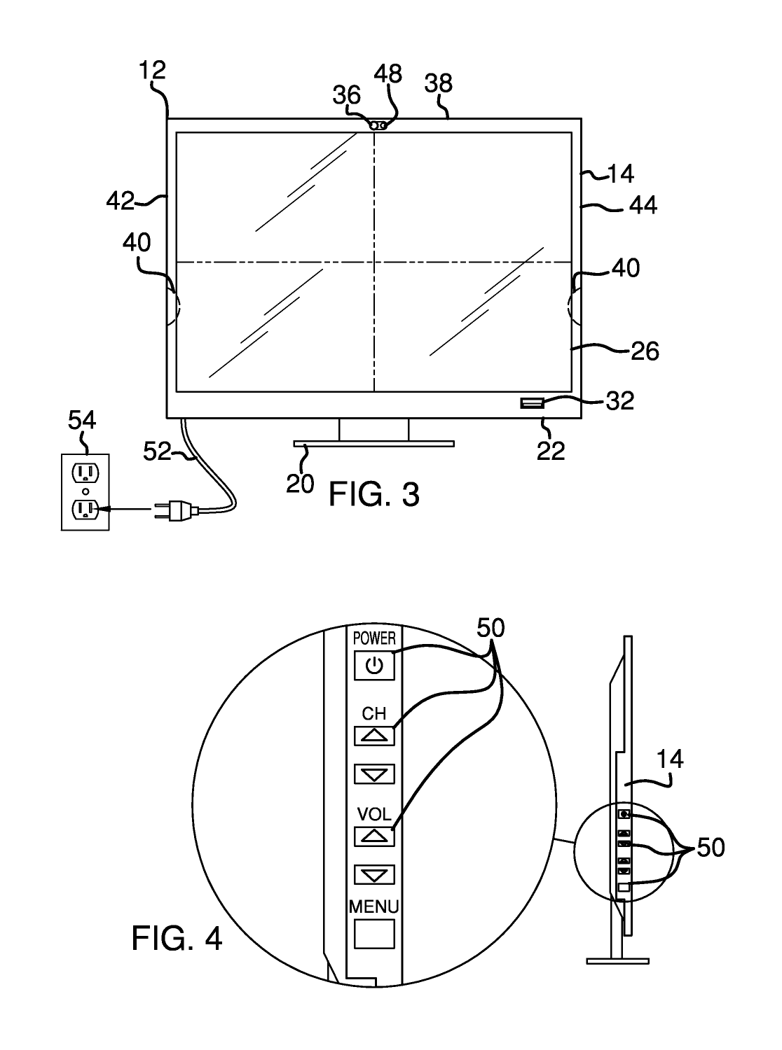

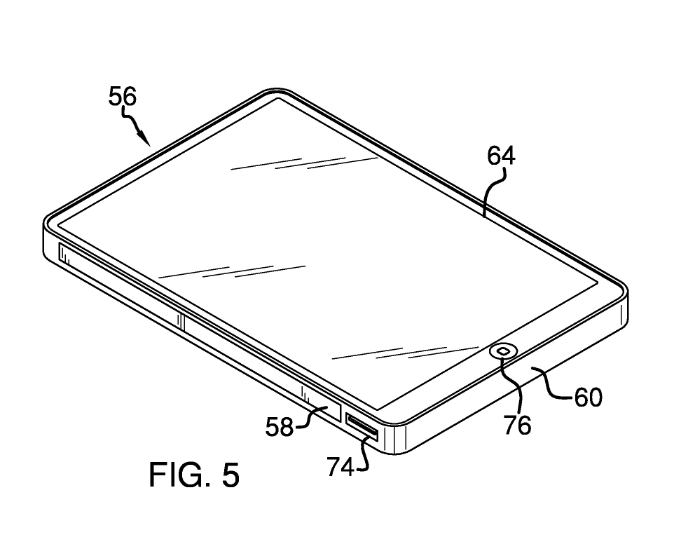

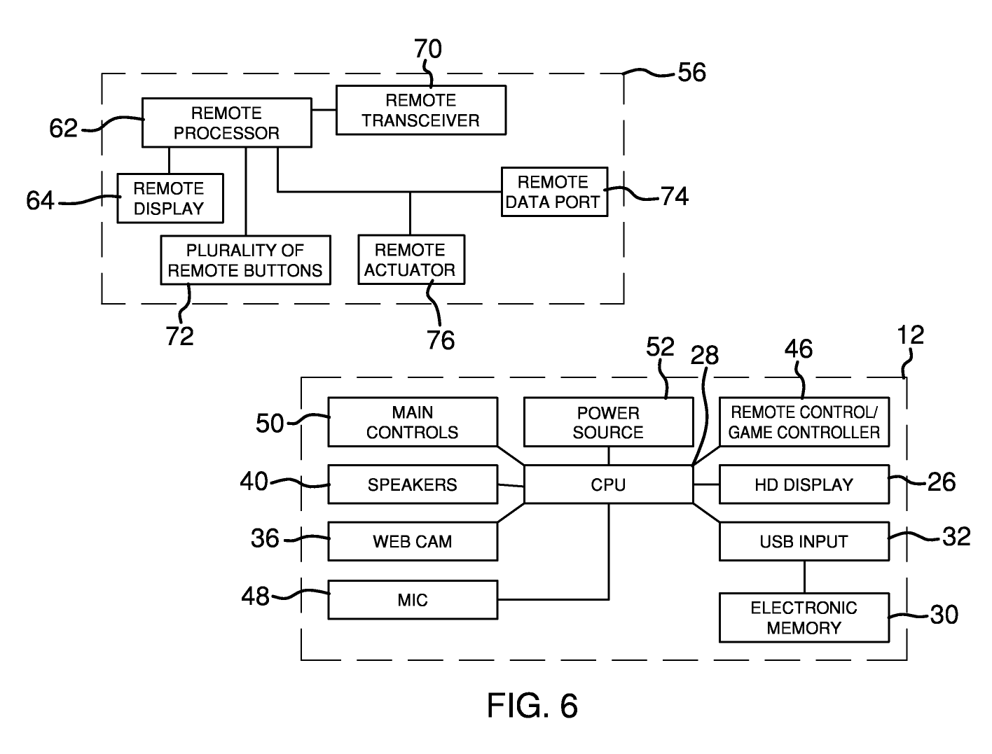

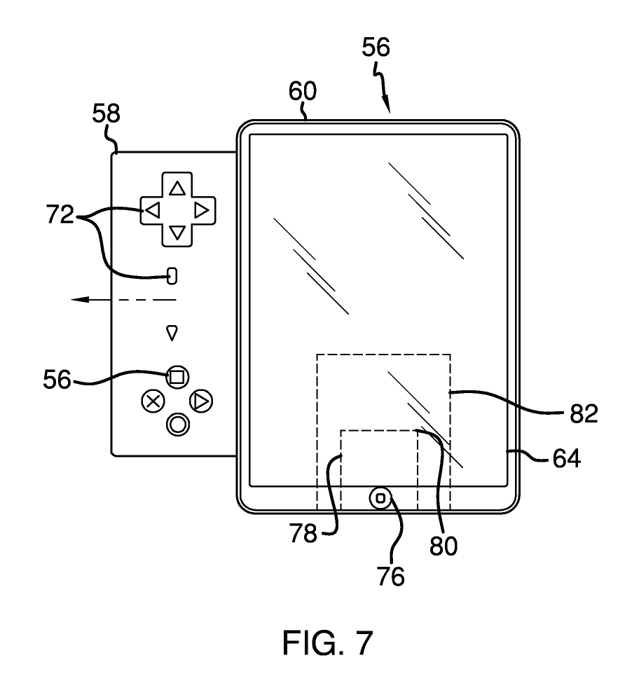

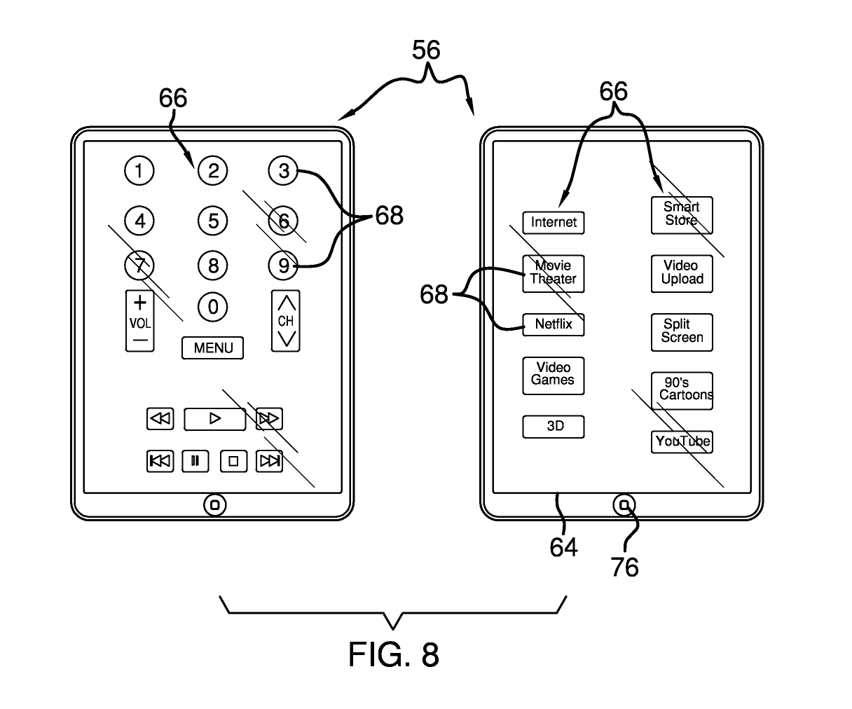

With reference now to the drawings, and in particular to FIGS. 1 through 8 thereof, a new television device embodying the principles and concepts of an embodiment of the disclosure and generally designated by the reference numeral 10 will be described.

As best illustrated in FIGS. 1 through 8, the television assembly 10 generally comprises a housing 12. The housing 12 has an outer edge 14 extending between a front side 16 and a back side 18 of the housing 12. A stand 20 is coupled to a bottom side 22 of the outer edge 14. The stand 20 supports the housing 12 above a support surface 24.

A base display 26 is coupled to the front side 16 so the base display 26 is visible to an observer. The base display 26 may be an LED display or the like. A base processor 28 is positioned within the housing 12. The base processor 28 is electrically coupled to the base display 26. An electronic memory 30 is positioned within the housing 12. The electronic memory 30 is electrically coupled to the base processor 28.

A base data port 32 is coupled to the front side 16. The base data port 32 is electrically coupled to the electronic memory 30. The base data port 32 may be electrically coupled to an external electronic device 34, allowing the data to be transferred between the external electronic device 34 and the electronic memory 30. Additionally, the base data port 32 may be USB port of the like.

A camera 36 is coupled to the front side 16. The camera 36 is positioned between the display 26 and a top side 38 of the outer edge 14. Moreover, the camera 36 records a video of an area located in front of the housing 12. The camera 36 is electrically coupled to the base processor 28. The camera 36 may be a digital video camera or the like.

A pair of speakers 40 is each coupled to an associated one of a first lateral side 42 and a second lateral side 44 of the outer edge 14. Each of the speakers 40 is electrically coupled to the base processor 28. The speakers 40 emit audible sounds.

A base transceiver 46 is positioned within the housing 12. The base transceiver 46 is electrically coupled to the base processor 28. The base transceiver 46 is in electromagnetic communication with a communications network to deliver and receive a video from the communications network. The communications network may be the internet or the like. The base transceiver 46 may be an RF transceiver or the like. Additionally, the base transceiver 46 may utilize a WPAN signal or the like.

A microphone 48 is coupled to the front side 16. The microphone 48 receives audible commands. The microphone 48 is electrically coupled to the base processor 28 to send the audible commands to the base processor 28. The base display 26 depicts indicia associated with the audible commands. The audible commands may comprise a record command, a play command, a transmit command, a receive command or other similar audible commands related to the operation of the assembly.

A plurality of base buttons 50 is provided. Each of the base buttons 50 is coupled to the first lateral side 42 of the outer edge 14. The base buttons 50 are electrically coupled to the base processor 28. Each of the base buttons 50 controls an associated one of a plurality of commands related to the base display 26, the camera 36, the base transceiver 46, the microphone 48 and the speakers 40.

A base power supply 52 is positioned within the housing 12. The base power supply 52 is electrically coupled to the base processor 28. The base power supply 52 is electrically coupled to a power source 54. The power source 54 may be an electrical outlet or the like.

A remote control 56 is provided. The remote control 56 has a game section 58 slidably coupled to a display section 60. The game section 58 is selectively extendable outwardly from the display section 58 or stored within the display section 58.

A remote processor 62 is positioned within the remote control 56. A remote display 64 is coupled to the display section 60 of the remote control 56. The remote display 64 is electrically coupled to the remote processor 62. The remote display 64 may be a touch screen or the like. The remote display 64 displays indicia 66. The indicia 66 may comprise icons 68 related to operational functions of the base display 26, the base transceiver 46, the camera 36 and the microphone 48. The remote display 64 may be touched to select one of the icons 68.

A remote transceiver 70 is positioned within the remote control 56. The remote transceiver 70 is electrically coupled to the remote processor 62. The remote transceiver 70 is in electromagnetic communication with the base transceiver 46. The remote transceiver 70 may be an RF transceiver or the like.

A plurality of remote buttons 72 is couple to the game section 58. Each of the remote buttons 72 is electrically coupled to the remote processor 62. The remote transceiver 70 communicates manipulation of the remote buttons 72 the base transceiver 46, allowing for control of game play displayed on the base display 26.

A remote data port 74 is coupled to the display section 58. The remote data port 74 is electrically coupled to the remote processor 62. The remote data port 74 may be selectively electrically coupled to the external electronic device 34, allowing data to be transferred between the external electronic device 34 and the remote processor 62. The remote data port 74 may be a USB port or the like.

A remote actuator 76 is coupled to the display section 60. The remote actuator 76 is electrically coupled to the remote processor 62 to selectively actuate and de-actuate the remote processor 62.

A remote power supply 78 is positioned within the display section 60. The remote power supply 78 is electrically coupled to the remote processor 62. The remote power supply 78 comprises at least one battery 80. A battery cover 82 is removably coupled to the display section 60. The remote power supply 78 is positioned beneath the battery cover 82.

In use, a user 84 speaks verbal commands in order to control the base display 26. The microphone 48 is used to control all of the operational functions of the assembly 10, allowing hands free operation of the assembly 10. The camera 36 is used to record a video of the user 84. The user 84 may upload the video to the internet directly from the assembly 10. Additionally, the assembly 10 may be used to download videos from the internet, allowing the video to be displayed on the base display 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A television assembly for receiving voice commands, said assembly comprising:
a housing configured to be positioned on a support surface;
a base display coupled to said housing such that base display is configured to be visible to an observer;
a base processor positioned within said housing, said base processor being electrically coupled to said display;
a camera coupled to said housing, said camera recording a video, said camera being electrically coupled to said base processor;
a base transceiver positioned within said housing, said base transceiver being electrically coupled to said base processor, said base transceiver being in electromagnetic communication with a communications network such that said base transceiver is configured to deliver and receive a video from the communications network; and
a microphone coupled to said housing, said microphone receiving audible commands, said microphone being electrically coupled to said base processor to send the audible commands to said base processor, said base display depicting indicia associated with said audible commands.

2. The assembly according to claim 1, wherein said housing having an outer edge extending between a front side and a back side of said housing, said display being coupled to said front side, said camera being coupled to said front side such that said camera is configured to record a video of an area located in front of said housing, said microphone being coupled to said front side.

3. The assembly according to claim 2, further comprising a pair of speakers each coupled to an associated one of a first lateral side and a second lateral side of said outer edge, said speakers each being electrically coupled to said base processor, said speakers emitting audible sounds.

4. The assembly according to claim 3, further comprising a plurality of base buttons coupled to a first lateral side of said outer edge, said base buttons being electrically coupled to said base processor, each of said base buttons controlling an associated one of a plurality of commands related to said display, said camera, said transceiver, said microphone and said speakers.

5. The assembly according to claim 1, further comprising a base power supply positioned within said housing, said base power supply being electrically coupled to said base processor, said base power supply being electrically coupled to a power source.

6. A television assembly for receiving voice commands, said assembly comprising:
a housing, said housing having an outer edge extending between a front side and a back side of said housing, said housing being configured to be positioned on a support surface, said display being coupled to said front side, said camera being coupled to said front side such that said camera is configured to record a video of an area located in front of said housing, said microphone being coupled to said front side
a base display coupled to said front side such that said base display is visible to an observer;
a base processor positioned within said housing, said base processor being electrically coupled to said base display;
a camera coupled to said front side such that said camera records a video of an area located in front of said housing, said camera being electrically coupled to said base processor;
a pair of speakers each coupled to an associated one of a first lateral side and a second lateral side of said outer edge, said speakers each being electrically coupled to said base processor, said speakers emitting audible sounds;
a base transceiver positioned within said housing, said base transceiver being electrically coupled to said base processor, said base transceiver being in electromagnetic communication with a communications network such that said base transceiver is configured to deliver and receive a video from the communications network;
a microphone coupled to said front side, said microphone receiving audible commands, said microphone being electrically coupled to said base processor to send the audible commands to said base processor, said display depicting indicia associated with said audible commands;
a plurality of base buttons coupled to said first lateral side of said outer edge, said base buttons being electrically coupled to said base processor, each of said base buttons controlling an associated one of a plurality of commands related to said base display, said camera, said base transceiver, said microphone and said speakers; and
a base power supply positioned within said housing, said base power supply being electrically coupled to said base processor, said base power supply being electrically coupled to a power source.
